(19) United States
(12) Patent Application Publication
(10) Pub. No.: US 2008/0240474 A1
(43) Pub. Date: Oct. 2, 2008

(54) Audio Output Apparatus, Audio Signal Output Adjusting Method, Audio Signal Output Adjusting Process Program, and the Like

(76) Inventors: Yuji Sakamoto, Saitama (JP); Kenji Morita, Saitama (JP); Yoshiya Nonaka, Saitama (JP)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/593,745

(22) PCT Filed: Mar. 9, 2005
(86) PCT No.: PCT/JP2005/004045

§ 371 Date: Sep. 22, 2006

(30) Foreign Application Priority Data
Mar. 24, 2004 (JP) 2004-086735

(51) Int. Cl. H04R 5/02

(52) U.S. Cl. 381/300

(57) ABSTRACT

The present invention provides an audio output apparatus, an audio signal output adjusting method, an audio signal output adjusting process program, and the like capable of preventing the user (listener) from making a complicated sound field setting even in the case where the position of a center speaker is changed.

An audio output apparatus having:
at least one first speaker changeably installed in a predetermined position and outputting an audio signal; and
a plurality of second speakers fixedly installed in positions different from the position of the first speaker and different from each other, and outputting audio signals,
the apparatus generating a sound field according to position relations among the install position of the first speaker and the install positions of the plurality of second speakers when the position of the user is used as a reference,
wherein the apparatus comprises:
a plurality of audio signal detecting means provided in or near the install positions of the second speakers and detecting audio signals output from the first speaker;
speaker position calculating means for obtaining the audio signals detected by the audio signal detecting means, detecting that the install position of the first speaker has been changed on the basis of the obtained audio signals, and calculating the changed install position; and
audio signal output adjusting means, on the basis of the changed install position of the first speaker and the install positions of the plurality of second speakers, that adjusts output of the audio signal from at least one of the first speaker whose install position has been changed and the plurality of second speakers so that a sound field according to the position relations before the install position of the first speaker was changed is maintained.

### TECHNICAL FIELD

The present invention relates to a technical field of an audio output apparatus and method, the apparatus including at least one first speaker changeably installed in a predetermined position and outputting an audio signal and a plurality of second speakers fixedly installed in positions different from the position of the first speaker and different from each other, and outputting audio signals, and the apparatus generating a sound field according to the positional relations among the install position of the first speaker and the install positions of the plurality of second speakers when the position of the user is a reference.

### BACKGROUND ART

In recent years, a 5.1ch (channel) surround-compatible (Dolby surround-compatible) or 6.1ch surround-compatible DVD (Digital Versatile Disc) reproducing apparatus is known. In the case of, for example, a 5.1ch surround-compatible DVD reproducing apparatus, the apparatus is provided with a center speaker, a left front speaker, a right front speaker, a left (rear) surround speaker, a right (rear) surround speaker, and a sub-woofer speaker. With the apparatus, the user (listener) can enjoy powerful stereo sound.

However, to enjoy powerful stereo sound, the user (listener) has to set a sound field adapted to the 5.1ch surround sound. In the setting, the user (listener) has to install the six speakers in proper positions by using the position of himself/herself as a reference. For example, the user (listener) usually has to install the center speaker for outputting an audio signal of a speech or the like in the same position as that of a monitor for displaying a video image and dispose the right and left front speakers and the right and left rear speakers bilateral-symmetrically. The work is very troublesome for the user (listener). Further, to set the balance of volumes of the speakers, the user (listener) has to perform a troublesome work of inputting the distances between the position of the user (listener) and the speakers.

To solve the trouble, in an audio output apparatus disclosed in Patent Document 1, by providing a scale for a cable connecting the apparatus body to the center speaker, the distance from the listening position to the center speaker can be easily and reliably input, so that a sound field can be easily set. Patent Document 1: Japanese Patent Application Laid-open No.

### DISCLOSURE OF THE INVENTION

### Problems to be Solved by the Invention

The position of the monitor, however, is often changed (moved) by the user (listener). In this case, usually, the position of the center speaker is also changed. Therefore, in a conventional sound field output apparatus, each time the center speaker is changed, the user (listener) himself/herself has to make the setting as described above and there is a problem that it is very troublesome for the user (listener).

An object of the invention is to provide an audio output apparatus, an audio signal output adjusting method, an audio signal output adjusting process program, and the like solving the above-described problem and capable of preventing the user (listener) from making a complicated sound field setting again even in the case where the position of the center speaker is changed.

### Means for Solving the Problems

In order to solve the above problem, the invention of claim 1 relates to an audio output apparatus having:

at least one first speaker changeably installed in a predetermined position and outputting an audio signal; and

a plurality of second speakers fixedly installed in positions different from the position of the first speaker and different from each other, and outputting audio signals,

the apparatus generating a sound field according to position relations among the install position of the first speaker and the install positions of the plurality of second speakers when the position of the user is used as a reference,

wherein the apparatus comprises:

a plurality of audio signal detecting means provided in or near the install positions of the second speakers and detecting audio signals output from the first speaker; speaker position calculating means for obtaining the audio signals detected by the audio signal detecting means, detecting that the install position of the first speaker has been changed on the basis of the obtained audio signals, and calculating the changed install position; and

audio signal output adjusting means, on the basis of the changed install position of the first speaker and the install positions of the plurality of second speakers, that adjusts output of the audio signal from at least one of the first speaker whose install position has been changed and the plurality of second speakers so that a sound field according to the position relations before the install position of the first speaker was changed is maintained.

The invention of claim 5 relates to an audio signal output adjusting apparatus having:

at least one first speaker changeably installed in a predetermined position and outputting an audio signal;

a plurality of second speakers fixedly installed in positions different from the position of the first speaker and different from each other, and outputting audio signals;

a plurality of audio signal detecting means provided in or near the install positions of the second speakers and detecting audio signals output from the first speaker; and

speaker position calculating means for obtaining the audio signals detected by the audio signal detecting means, detecting that the install position of the first speaker has been changed on the basis of the obtained audio signals, and calculating the changed install position,

wherein on the basis of the changed install position of the first speaker and the install positions of the plurality of second speakers, output of the audio signal from at least one of the first speaker whose install position has been changed and the plurality of second speakers is adjusted so that a sound field according to the position relations among the install position of the first speaker before the change and the install positions of the plurality of second speakers when the position of the user is used as a reference is maintained.

The invention of claim 6 relates to an audio signal output adjusting method performed by an audio output apparatus having:

at least one first speaker changeably installed in a predetermined position and outputting an audio signal;

a plurality of second speakers fixedly installed in positions different from the position of the first speaker and different from each other, and outputting audio signals; and

a plurality of audio signal detecting means provided in or near the install positions of the second speakers and detecting the audio signals output from the first speaker,

the method comprising:

a step of obtaining the audio signals detected by the audio signal detecting means, detecting that the install position of the first speaker has been changed on the basis of the obtained audio signals, and calculating the changed install position; and

a step of, on the basis of the changed install position of the first speaker and the install positions of the plurality of second speakers, adjusting output of the audio signal from at least one of the first speaker whose install position has been changed and the plurality of second speakers so that a sound field according to the position relations among the install position of the first speaker before the change and the install positions of the plurality of second speakers when the position of the user is used as a reference is maintained.

The invention of claim 7 relates to an audio signal output adjusting process program for a computer included in an audio output apparatus having:

at least one first speaker changeably installed in a predetermined position and outputting an audio signal;

a plurality of second speakers fixedly installed in positions different from the position of the first speaker and different from each other, and outputting audio signals;

a plurality of audio signal detecting means provided in or near the install positions of the second speakers and detecting audio signals output from the first speaker; and

speaker position calculating means for obtaining the audio signals detected by the audio signal detecting means, detecting that the install position of the first speaker has been changed on the basis of the obtained audio signals, and calculating the changed install position,

wherein the program makes the computer function to adjust, on the basis of the changed install position of the first speaker and the install positions of the plurality of second speakers, output of the audio signal from at least one of the first speaker whose install position has been changed and the plurality of second speakers so that a sound field according to the position relations among the install position of the first speaker before the change and the install positions of the plurality of second speakers when the position of the user is used as a reference is maintained.

The invention of claim 8 relates to a recording medium on which the audio signal output adjusting process program according to claim 7 is computer-readably recorded.

### BRIEF DESCRIPTION OF THE DRAWINGS

FIG. 1 is a diagram showing an example of a schematic configuration of a DVD reproducing apparatus in an embodiment of the invention.

FIG. 2 is a diagram showing an example of the positional relations among the install position of a center speaker 16a and install positions of four speakers 16b, 16c, 16d, and 16e when the position of the user (listener) is used as a reference.

FIG. 3 is a diagram showing an example of the principle of calculating (estimating) the install position of the center speaker 16a.

FIG. 4 is a diagram showing an example of the positional relations among the install position of the center speaker 16a and the install positions of the four speakers 16b, 16c, 16d, and 16e when the position of the user (listener) is used as a reference in the case where the install position of the center speaker 16a is changed.

FIG. 5 is a flowchart showing speaker position detecting process in a speaker position detector 19.

FIG. 6 is a flowchart showing audio signal output adjusting process in a controller 20.

### DESCRIPTION OF REFERENCE NUMERALS

1 DVD reproducing apparatus
11 information reproducer
12 digital signal processor
13 video signal processor
14 monitor
15 audio signal processor
16 speaker group
17 microphone group
18 ADC
19 speaker position detector
20 controller
21 storage
22 operating unit

### BEST MODE FOR CARRYING OUT THE INVENTION

Preferred embodiments of the invention will be described below with reference to the appended drawings. The embodiment described below relates to the case of applying the present invention to a 5.1ch surround-compatible DVD reproducing apparatus.

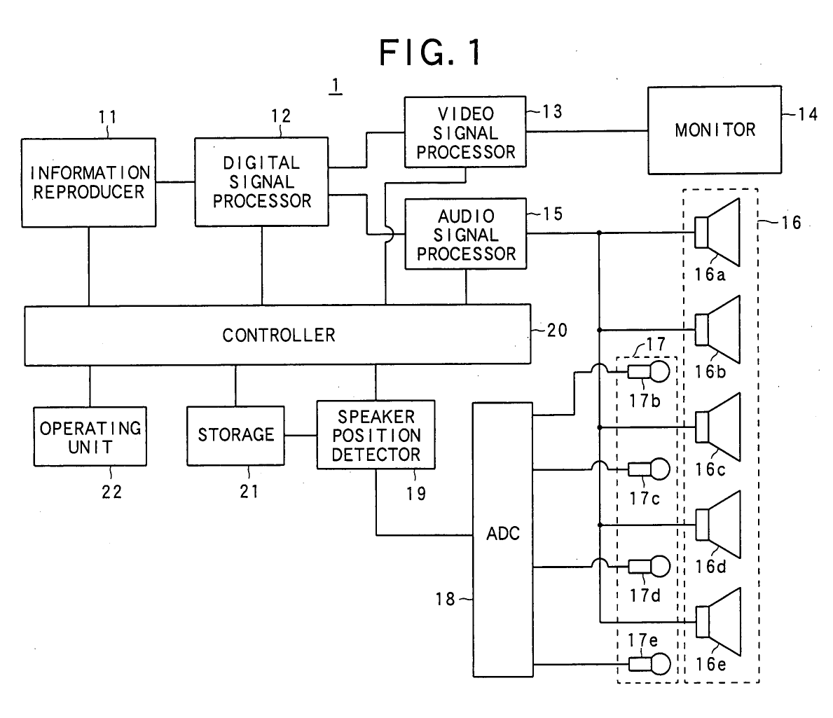

First, with reference to FIG. 1 and the like, the configuration and functions of the DVD reproducing apparatus in the embodiment will be described.

FIG. 1 is a diagram showing an example of a schematic configuration of the DVD reproducing apparatus in the embodiment. As shown in FIG. 1, a DVD reproducing apparatus 1 has an information reproducer 11, a digital signal processor (DSP) 12, a video signal processor 13, a monitor 14, an audio signal processor 15, a speaker group 16, a microphone group 17, an ADC (Analog Digital Converter) 18, a speaker position detector 19, a controller 20, a storage (for example, a hard disk or a nonvolatile memory) 21, and an operating unit 22.

The information reproducer 11 has, although not shown, a spindle motor for rotating a DVD (for example, DVD-Video) mounted in a predetermined clamp position at predetermined linear speed (or angular velocity), an optical pickup for optically reading information recorded on the DVD and photoelectrically converting the read information to an electric signal, an RF amplifier for generating an RF (Radio Frequency) signal from the electric signal output from the optical pickup and generating various error signals of tracking error, focusing error, and the like from the electric signal, and a servo control circuit for performing servo controls (focus servo, tracking servo, and the like) on the spindle motor and the optical pickup on the basis of various error signals (focus error signal, tracking error signal, and the like) generated by the RF amplifier. The RF signal generated by the RF amplifier is output to the digital signal processor 12.

The digital signal processor 12 converts the RF signal from the information reproducer 11 to a digital signal, performs, for example, a signal demodulating process and an error correcting process conforming to the standard of DVD-Video on the digital signal, and temporarily stores the resultant signal to a buffer memory (not shown). Further, the digital signal processor 12 splits (stream splitting process) the stored demodulated data into a digital video signal (video data), a digital audio signal (audio data), a control signal, and the like in accordance with an instruction from the controller 12, and outputs the digital video signal, digital audio signal, and control signal to the video signal processor 13, the audio signal processor 15, and the controller 20, respectively.

The video signal processor 13 has, although not shown, a video decoder, a driver, and the like, performs a predetermined decoding process on the digital video signal, and outputs the decoded digital video signal to the monitor 14.

The audio signal processor 15 has, although not shown, an audio decoder, a D/A converter, an AMP (amplifier), and the like. For example, the audio signal processor 15 performs a predetermined decoding process by the audio decoder on digital audio signals compressed by the Dolby digital (AC-3) (registered trademark) system to thereby demodulate the 5.1ch audio signals, converts the digital audio signals to analog audio signals by the D/A converter, amplifies (level-adjusts) the analog audio signals by the amplifier, and outputs the amplified signals to the speaker group 16. Specifically, from the audio signal processor 15, the audio signals for the center channel, the right and left front channels, the right and rear surround (rear) channels, and the sub-woofer channel are output.

The speaker group 16 has a center speaker 16a as a first speaker, and a left front speaker 16b, a right front speaker 16c, a left (rear) surround speaker 16d, and a right (rear) surround speaker 16e as a plurality of second speakers (in the example of FIG. 1, the sub-woofer speaker is not shown). The center speaker 16a outputs, as a sound wave, the audio signal for the center channel from the audio signal processor 15. The left front speaker 16b, right front speaker 16c, left (rear) surround speaker 16d, right (rear) surround speaker 16e, and sub-woofer speaker output, as sound waves, the audio signals for the left front channel, right front channel, left (rear) surround channel, right (rear) surround channel, and sub-woofer channel, respectively.

The center speaker 16a is installed in a predetermined position in which the monitor 14 is installed (for example, attached integrally with the monitor 14). The position of the center speaker 16a is changeable (movable) together with the monitor 14.

On the other hand, the left front speaker 16b, right front speaker 16c, left (rear) surround speaker 16d, and right (rear) surround speaker 16e are fixedly installed in positions different from the position of the center speaker 16a and different from each other.

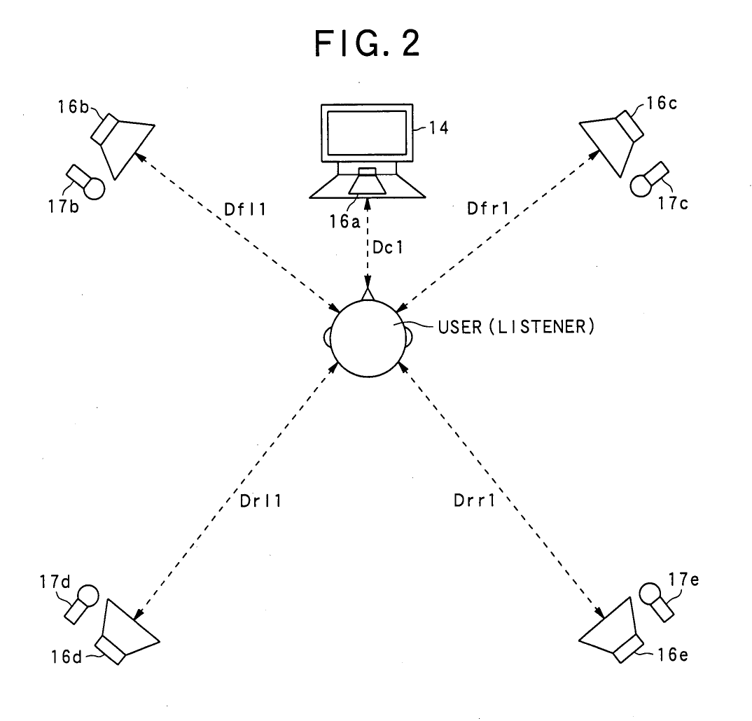

FIG. 2 is a diagram showing an example of the positional relations among the install position of the center speaker 16a and the install positions of the four speakers 16b, 16c, 16d, and 16e when the position of the user (listener) is used as a reference. As shown in FIG. 2, the user (listener) is positioned so as to face the monitor 14 and listens to sound such as a speech or the like output from the center speaker 16a. In the example of FIG. 2, the user (listener) is positioned slightly forward of the center of a square shape formed by the four speakers 16b, 16c, 16d, and 16e, and listens to sound of a sound effect, movement sound of an object, and the like from the speakers.

Information (for example, position coordinates (X, Y)) of the install position of the center speaker 16a and the install positions of the speakers 16b, 16c, 16d, and 16e is entered, for example, by the user (listener) via the operating unit 22 and pre-stored in the storage 21. The position of the user (listener) is also pre-stored in the storage 21. The information of the install position of the center speaker 16a stored in the storage 21 is updated each time the position is changed. On the basis of the information of the positions of the speakers and the user (listener), the distances among speakers and the distances between the speakers and the user (listener) are properly calculated.

The microphone group 17 has microphones 17b, 17c, 17d, and 17e as a plurality of audio signal detecting means for detecting audio signals (collecting sound) output from the center speaker 16a, which are provided in or near the install positions of the speakers 16b, 16c, 16d, and 16e, respectively. Specifically, as shown in FIG. 2, the microphone 17b corresponds to the left front speaker 16b. The microphone 17c corresponds to the right front speaker 16c. The microphone 17d corresponds to the left (rear) surround speaker 16d. The microphone 17e corresponds to the right (rear) surround speaker 16e. Audio signals (analog audio signals) detected by the microphones 17b, 17c, 17d, and 17e are output to the ADC 18. The microphones 17b, 17c, 17d, and 17e may be replaced with the speakers 16b, 16c, 16d, and 16e which are in the same positions, respectively (that is, the speakers 16b, 16c, 16d, and 16e function as microphones).

The ADC 18 converts the audio signals (analog audio signals) from the microphones 17b, 17c, 17d, and 17e to digital audio signals, and outputs the digital audio signals to the speaker position detector 19.

The speaker position detector 19 as speaker position detecting means is constructed by a digital signal processor or the like. By executing a predetermined program, the speaker position detector 19 obtains the audio signals detected by the speakers 16b, 16c, 16d, and 16e via the ADC 18, on the basis of the audio signals, detects that the install position of the center speaker 16a is changed, and calculates the changed install position.

More concretely, first, the speaker position detector 19 detects (captures) a special signal (for example, a special signal (an audio signal of “Pi” or the like) output only from the center speaker 16a in response to an instruction of the controller 20 at the time of activation (startup) by power-on of the DVD reproducing apparatus 1) included in each of audio signals supplied from the ADC 18. Subsequently, the speaker position detector 19 calculates the time difference between the detection timing of a special signal and the output timing of the special signal (that is, the difference of reach time of the special signal from a sound source) for each of the audio signals (that is, for each of the microphones 17b, 17c, 17d, and 17e). The output timing of the special signal is recognized by the controller 20 and supplied from the controller 20 to the speaker position detector 19. The special signal output from the center speaker 16a may be output in response to depression of a predetermined operation button in the operating unit 22.

The time difference is stored in the storage 21 in association with each of the microphones 17b, 17c, 17d, and 17e. The speaker position detector 19 compares the time difference calculated this time with the time difference calculated before and stored in the storage 21. When the times do not coincide (are different from each other), the speaker position detector 19 detects that the install position of the center speaker 16a has been changed. A change in the install position of the center speaker 16a may be also detected by calculation of the changed install position of the center speaker 16a as follows.

The speaker position detector 19 multiplies the calculated time difference with ray velocity, calculates the distance from the sound source (the install position of the center speaker 16a) to each of the microphones 17b, 17c, 17d, and 17e (the install positions of the speakers 16b, 16c, 16d, and 16e), and calculates (estimates) the install position of the center speaker 16a by using information (for example, the position coordinates (X, Y)) of at least three distances out of the calculated distances and the install positions of three speakers corresponding to the three distances. The information (for example, the position coordinates (X, Y)) of the install position of the center speaker 16a calculated in such a manner is stored in the storage 21, and supplied to the controller 20.

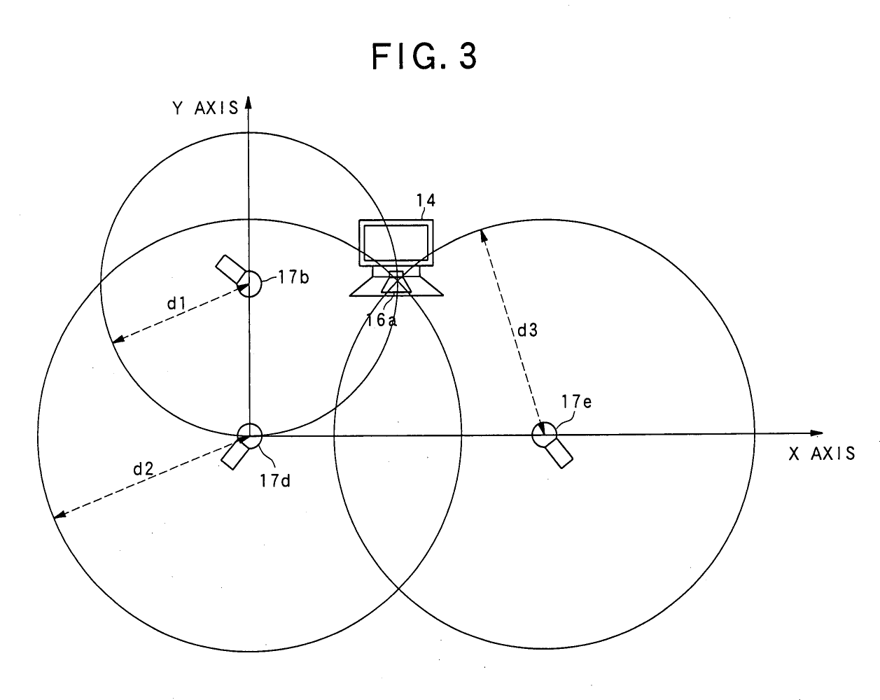

FIG. 3 is a diagram for explaining an example of the principle of calculating (estimating) the install position of the center speaker 16a. In the example of FIG. 3, the distances from the install positions of the three microphones 17b, 17d, and 17e to the install position of the center speaker 16a are d1, d2, and d3, respectively. It is estimated that the center speaker 16a is positioned in the intersection of three circles using the position coordinates of the microphones 17b, 17d, and 17e (the position coordinates of the speakers 16b, 16c, and 16d) as center and using d1, d2, and d3 as radius. That is, the speaker position detector 19 calculates the coordinates of the intersection as the install position of the center speaker 16a.

FIG. 3 shows an example of calculating the install position of the center speaker 16a on the basis of the install positions of the three microphones 17b, 17d, and 17e and the distances from the install positions to the center speaker 16a. It is also possible to calculate a plurality of install positions of the center speaker 16a while changing the combination of the three microphones (for example, a combination of three microphones 17c, 17d, and 17e), for example, calculate an average of the plurality of install positions, and sets the average as the install position of the center speaker 16a. With such a configuration, the install position of the center speaker 16a can be calculated more accurately.

Alternatively, the install position of the center speaker 16a may be calculated from the install positions of any two microphones in the four microphones 17b, 17c, 17d, and 17e and the distances to the center speaker 16a from the install positions. In this case, two intersections of two circles exist. Consequently, one of the intersections has to be selected based on some information.

The controller 20 includes a CPU having a computing function, a RAM for work, and a ROM for storing various processing programs and data. By executing a predetermined program (including an audio signal output adjusting process program), according to an instruction signal from the operating unit 22, the controller 20 controls the operations of the information reproducer 11, digital signal processor 12, video signal processor 13, audio signal processor 15, and speaker position detector 19. The operating unit 22 has operation buttons for giving various instructions (for example, a reproduction instruction, a display instruction, and the like) from the user (listener) to the controller 20.

For example, the controller 20 controls the information reproducer 11 and the digital signal processor 12 to reproduce recorded information from a DVD and extract the audio signal, and controls the audio signal processor 15 to output the audio signal for the center channel to the center speaker 16a, the audio signal for the left front channel to the left front speaker 16b, the audio signal of the right front channel to the right front speaker 16c, the audio signal of the left (rear) surround channel to the left (rear) surround speaker 16d, and the audio signal for the right (rear) surround channel to the right (rear) surround speaker 16e.

Further, the controller 20 adjusts output of the audio signal from at least one of the center speaker 16a whose install position has been changed and the plurality of speakers 16b, 16c, 16d, and 16e so that the sound field according to the positional relations before a change in the install position of the center speaker 16a is maintained (so as to be adjusted to the sound field which was set before) on the basis of the changed install position of the center speaker 16a and the install positions of the plurality of speakers 16b, 16c, 16d, and 16e.

To “adjust output of the audio signal”, for example, the controller 20 controls the audio signal processor 15 to adjust the output volume level of each audio signal or the output timing (for example, to delay the audio signal of a certain channel by predetermined time), or change allocation of output of the audio signals to the plurality of speakers 16b, 16c, 16d, and 16e (for example, to make the audio signal of the left front channel output to the left (rear) surround speaker 16d).

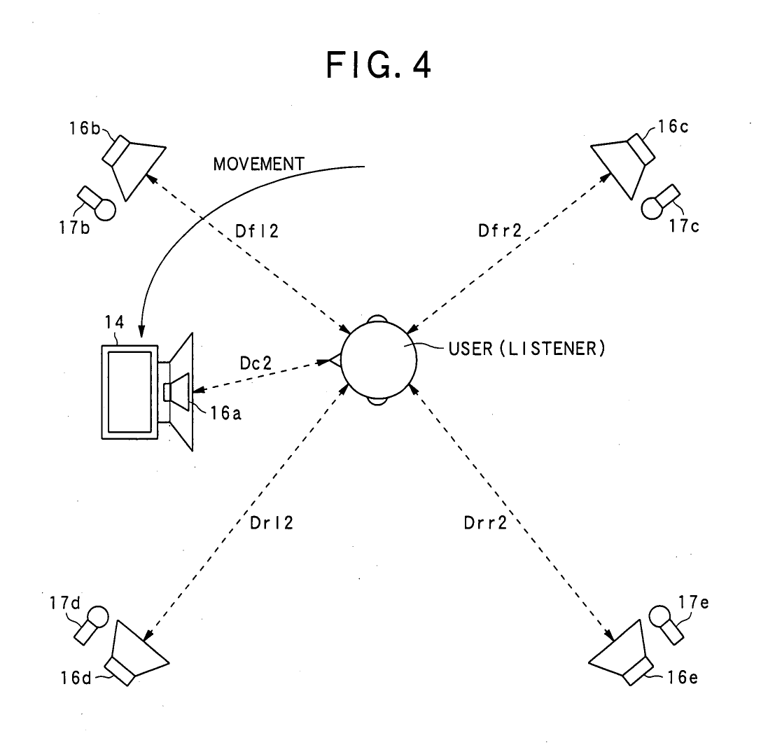

FIG. 4 is a diagram showing an example of the positional relations among the install position of the center speaker 16a and the install positions of the four speakers 16b, 16c, 16d, and 16e when the position of the user (listener) is used as a reference in the case where the install position of the center speaker 16a is changed. In the example of FIG. 4, the center speaker 16a is changed from the position in the example of FIG. 2 to a position between the left front speaker 16b and the left (rear) surround speaker 16d. Even in the case where the positional relations are changed as shown in FIG. 4, the sound field according to the positional relations shown in FIG. 2 before the change of the install position of the center speaker 16a is maintained by adjustment of output of the audio signal by the controller 20.

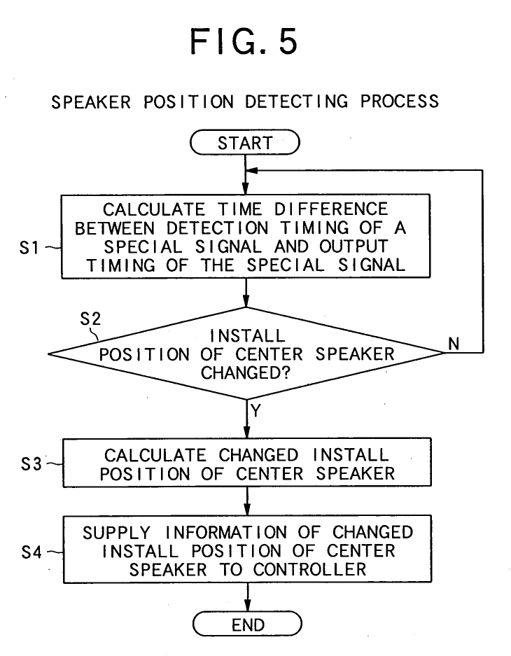

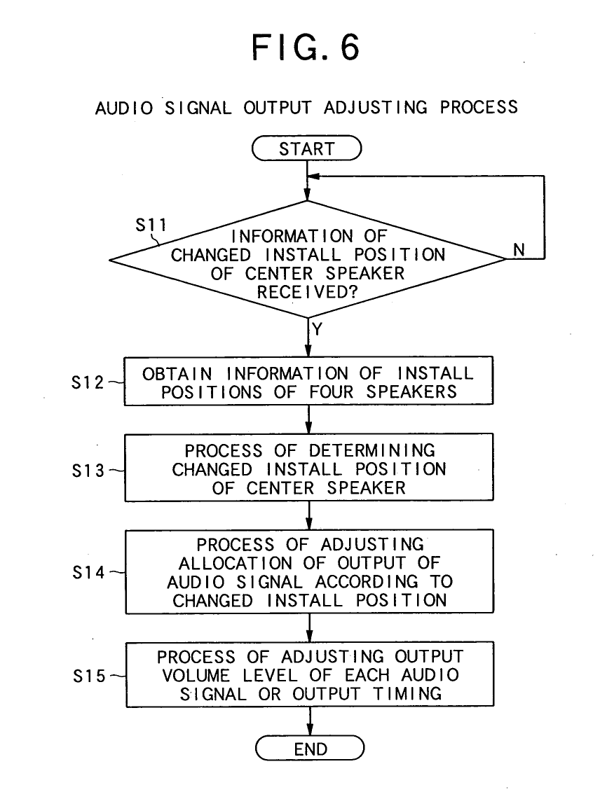

Next, with reference to FIGS. 5 and 6 and the like, the operation of the DVD reproducing apparatus in the embodiment will be described. FIG. 5 is a flowchart showing a speaker position detecting process in the speaker position detector 19. FIG. 6 is a flowchart showing an audio signal output adjusting process in the controller 20.

As a precondition of the following description of the operation, it is assumed that the center speaker 16a, left front speaker 16b, right front speaker 16c, left (rear) surround speaker 16d, and right (rear) surround speaker 16e have the positional relations as shown in FIG. 2, and the information (for example, the position coordinates (X, Y)) of the install positions of the speakers is, for example, input and set via the operating unit 22 by the user (listener) and pre-stored in the storage 21. It is also assumed that the information (for example, the position coordinates (X, Y)) of the position of the user (listener) is also input and set via the operating unit 22 by the user (listener), and is pre-stored in the storage 21.

First, when the user (listener) changes the install position of the center speaker 16a together with the position of the monitor 14 and, after that, the power source (not shown) of the DVD reproducing apparatus 1 is turned on or the operation button in the operating unit 22 is depressed, the speaker position detecting process and the audio signal output adjusting process are executed and, in response to the instruction of the controller 20, the audio signal including the special signal is output from the center speaker 16a via the audio signal processor 15.

The audio signals which are output in such a manner are detected by the microphones 17b, 17c, 17d, and 17e, output to the ADC 18, and converted to digital audio signals by the ADC 18, and the digital audio signals are output to the speaker position detector 19.

The speaker position detector 19 detects, as shown in FIG. 5, a special signal included in each audio signal and calculates the time difference (reach time difference) between the detection timing of each special signal and the output timing of the special signal for each audio signal (step S1).

Next, whether the install position of the center speaker 16a has been changed or not is determined (step S2). For example, the time difference calculated this time is compared with the time difference calculated before and stored in the storage 21. When they do not coincide with each other (are different from each other), it is determined that the install position of the center speaker 16a has been changed.

When it is determined that the install position of the center speaker 16a has been changed (Yin step S2), the calculated time difference is multiplied with ray velocity, distances from the install position of the center speaker 16a to the install positions of the speakers 16b, 16c, 16d, and 16e are calculated. Based on information (for example, position coordinates (X, Y)) of any three distances out of the calculated distances and the install positions of the three speakers corresponding to the distances, as described above, the changed install position of the center speaker 16a is calculated (step S3).

The information (for example, position coordinates (X, Y)) of the changed install position of the center speaker 16a calculated in such a manner is stored in the storage 21 and supplied to the controller 20 (step S4).

The process of step S3 may be executed irrespective of determination of a change in the install position of the center speaker 16a (that is, periodically even if the install position of the center speaker 16a is not changed).

Next, in the controller 20, as shown in FIG. 6, the information (for example, the position coordinates (X, Y)) of the changed install position of the center speaker 16a from the speaker position detector 19 is received (Y in step S11), the information (for example, the position coordinates (X, Y)) of the install positions of the four speakers 16b, 16c, 16d, and 16e is obtained from the storage 21 (step S12). After that, the position of the center speaker 16a among the speakers is determined (step S13), and allocation of output of audio signals according to the position is adjusted (step S14). The allocation adjustment is rough adjustment for maintaining a sound field according to the position relations before the install position of the center speaker 16a is changed.

More concretely, in the case where the center speaker 16a is positioned between the left front speaker 16b and the right front speaker 16c, the allocation is not changed, and the program moves to step S15. Specifically, the state is maintained in which output of the audio signal of the left front channel is allocated to the left front speaker 16b, output of the audio signal of the right front channel is allocated to the right front speaker 16c, output of the audio signal of the right (rear) surround channel is allocated to the right (rear) surround speaker 16e, and output of the audio signal of the left (rear) surround channel is allocated to the left (rear) surround speaker 16d.

On the other hand, in the case where the center speaker 16a is positioned between the right front speaker 16c and the right (rear) surround speaker 16e, allocation is changed as follows. Output of the audio signal of the left front channel is allocated to the right front speaker 16c. Output of the audio signal of the right front channel is allocated to the right (rear) surround speaker 16e. Output of the audio signal of the left (rear) surround channel is allocated to the left front speaker 16b. Output of the audio signal of the right (rear) surround channel is allocated to the left (rear) surround speaker 16d. After that, the program moves to step S15.

On the other hand, in the case where the center speaker 16a is positioned between the left (rear) surround speaker 16d and the right (rear) surround speaker 16e, allocation is changed as follows. Output of the audio signal of the left front channel is allocated to the right (rear) surround speaker 16e. Output of the audio signal of the right front channel is allocated to the left (rear) surround speaker 16d. Output of the audio signal of the left (rear) surround channel is allocated to the right front speaker 16c. Output of the audio signal of the right (rear) surround channel is allocated to the left front speaker 16b. After that, the program moves to step S15.

On the other hand, in the case where the center speaker 16a is positioned between the left front speaker 16b and the left (rear) surround speaker 16d, allocation is changed as follows. Output of the audio signal of the left front channel is allocated to the left (rear) surround speaker 16d. Output of the audio signal of the right front channel is allocated to the left front speaker 16b. Output of the audio signal of the left (rear) surround channel is allocated to the right (rear) surround speaker 16e. Output of the audio signal of the right (rear) surround channel is allocated to the right front speaker 16c. After that, the program moves to step S15.

Next, in step S15, by controlling the audio signal processor 15 by the controller 20, adjustment of the output volume level of each of audio signals and adjustment of output timings are performed. The adjustment of the output volume level and the adjustment of the output timing is fine adjustment for maintaining the sound field according to the position relations before the install position of the center speaker 16a is changed.

For example, the case where the center speaker 16a is changed from the install position shown in FIG. 2 to the install position shown in FIG. 4 will be described. A distance Dfr1 from the position of the right front speaker 16c before the install position is changed to the position of the user (listener) is equal to a distance Dfl1 from the position of the left front speaker 16b before the install position is changed to the position of the user (listener). On the other hand, a distance Dfl2 from the position of the left front speaker 16b after the install position is changed is not equal to a distance Drl2 from the position of the left (rear) surround speaker 16d after the install position is changed to the position of the user (listener) (the distance difference occurs).

Therefore, for example, when allocation of output of the audio signal for the left front channel is changed to the left (rear) surround speaker 16d and allocation of output of the audio signal for the right front channel is changed to the left front speaker 16b, a difference occurs also in time of reach of the audio signal to the position of the user (listener) by the amount corresponding to the distance difference (the distance difference between the distances Dfl2 and Drl2) and a difference also occurs in the volume of sound perceived by the user (listener) As a result, the sound field according to the position relations before the install position of the center speaker 16a is changed cannot be maintained.

Consequently, to eliminate the distance difference (the distance difference between the distance Dfl2 and the distance Drl2), the controller 20 controls the audio signal processor 15 so that, for example, the output volume level of the audio signal for the right front channel is decreased (specifically, the output volume level of the audio signal for the left front channel is decreased by the distance difference) or the output timing of the audio signal for the right front channel is delayed (specifically, the output timing of the audio signal for the right front channel is delayed from the output timing of the audio signal for the left front channel by the distance difference). In the case where the center speaker 16a is changed from the install position shown in FIG. 2 to the install position shown in FIG. 4, when the distance from the center speaker 16a to the position of the user (listener) becomes longer than, for example, the distance before the change, the controller 20 controls the audio signal processor 15 to increase the output volume level of the audio signal from the center speaker 16a or advance the output timing.

As described above, according to the embodiment, even in the case where the position of the center speaker 16a is changed when the user (listener) changes (moves) the install position of the monitor 14, output of the audio signal from at least one of the center speaker 16a whose install position has been changed and the plurality of speakers 16b, 16c, 16d, and 16e is automatically adjusted so as to maintain the sound field according to the position relations before the center speaker 16a is changed. Thus, the user (listener) does not have to make the troublesome sound field setting each time the position of the center speaker 16a is changed, and convenience for the user (listener) can be improved.

Although the embodiment has been described on assumption that the position of the user (listener) is fixed and pre-set, the invention is not limited to the case. For example, as the position of the user (listener), the position coordinates (X, Y) of the user (listener) may be input via the operating unit 22. In this case, it is expected that a difference occurs in the distances from the positions of the speakers to the position of the user (listener). In step S14 in the embodiment, the output volume level of the audio signal or the output timing is adjusted so as to cancel the distance difference.

Although an example of the case of applying the present invention to a DVD reproducing apparatus has been described in the foregoing embodiment, the invention is not limited to the case. For example, the invention may be applied to an on-vehicle AV (Audio Visual) device or an on-vehicle navigation system.

Although the invention is applied to the 5.1ch surround-compatible DVD reproducing apparatus in the foregoing embodiment, the invention is not limited to the apparatus but can be also applied to, for example, a 6.1ch surround-compatible DVD reproducing apparatus.

In the embodiment, a program executed by the speaker position detector 19 and the controller 20 may be downloaded from a server connected to the network such as the Internet or read from a recording medium such as a CD-ROM.

1. An audio output apparatus having:
at least one first speaker changeably installed in a predetermined position and outputting an audio signal; and
a plurality of second speakers fixedly installed in positions different from the position of the first speaker and different from each other, and outputting audio signals,
the apparatus generating a sound field according to position relations among the install position of the first speaker and the install positions of the plurality of second speakers when the position of the user is used as a reference,
wherein the apparatus comprises:
a plurality of audio signal detecting devices provided in or near the install positions of the second speakers which detect audio signals output from the first speaker;
a speaker position calculating device which obtains the audio signals detected by the audio signal detecting device, detecting that the install position of the first speaker has been changed on the basis of the obtained audio signals, and calculating the changed install position; and
an audio signal output adjusting device, on the basis of the changed install position of the first speaker and the install positions of the plurality of second speakers, that changes allocation of output of the audio signals to the plurality of second speakers, and adjusts output of the audio signal from at least one of the first speaker whose install position has been changed and the plurality of second speakers so that a sound field according to the position relations before the install position of the first speaker was changed is maintained.

2. The audio output apparatus according to claim 1,
wherein the audio signal output adjusting device adjusts at least one of an output volume level of the audio signal and an output timing of the audio signal.

3. (canceled)

4. The audio output apparatus according to claim 1,
wherein the speaker position calculating device calculates distances between the install position of the first speaker and the install positions of at least three second speakers, and calculates the install position of the first speaker by using the calculated distances and the install positions of the speakers corresponding to the calculated distances.

5. An audio signal output adjusting apparatus having:
at least one first speaker changeably installed in a predetermined position and outputting an audio signal;
a plurality of second speakers fixedly installed in positions different from the position of the first speaker and different from each other, and outputting audio signals;
a plurality of audio signal detecting devices provided in or near the install positions of the second speakers which detects audio signals output from the first speaker; and
a speaker position calculating device which obtains the audio signals detected by the audio signal detecting device, detecting that the install position of the first speaker has been changed on the basis of the obtained audio signals, and calculating the changed install position,
wherein on the basis of the changed install position of the first speaker and the install positions of the plurality of second speakers, allocation of output of the audio signals to the plurality of second speakers is changed, and output of the audio signal from at least one of the first speaker whose install position has been changed and the plurality of second speakers is adjusted so that a sound field according to the position relations among the install position of the first speaker before the change and the install positions of the plurality of second speakers when the position of the user is used as a reference is maintained.

6. An audio signal output adjusting method performed by an audio output apparatus having:
at least one first speaker changeably installed in a predetermined position and outputting an audio signal;
a plurality of second speakers fixedly installed in positions different from the position of the first speaker and different from each other, and outputting audio signals; and
a plurality of audio signal detecting device provided in or near the install positions of the second speakers and detecting the audio signals output from the first speaker,
the method comprising:
a process of obtaining the audio signals detected by the audio signal detecting device, detecting that the install position of the first speaker has been changed on the basis of the obtained audio signals, and calculating the changed install position; and
a process of, on the basis of the changed install position of the first speaker and the install positions of the plurality of second speakers, changing allocation of output of the audio signals to the plurality of second speakers, and adjusting output of the audio signal from at least one of the first speaker whose install position has been changed and the plurality of second speakers so that a sound field according to the position relations among the install position of the first speaker before the change and the install positions of the plurality of second speakers when the position of the user is used as a reference is maintained.

7. An audio signal output adjusting process program for a computer included in an audio output apparatus having:
at least one first speaker changeably installed in a predetermined position and outputting an audio signal;
a plurality of second speakers fixedly installed in positions different from the position of the first speaker and different from each other, and outputting audio signals;
a plurality of audio signal detecting devices provided in or near the install positions of the second speakers which detect audio signals output from the first speaker; and
a speaker position calculating device which obtains the audio signals detected by the audio signal detecting device, detecting that the install position of the first speaker has been changed on the basis of the obtained audio signals, and calculating the changed install position,
wherein the program makes the computer function to, on the basis of the changed install position of the first speaker and the install positions of the plurality of second speakers, change allocation of output of the audio signals to the plurality of second speakers, and adjust output of the audio signal from at least one of the first speaker whose install position has been changed and the plurality of second speakers so that a sound field according to the position relations among the install position of the first speaker before the change and the install positions of the plurality of second speakers when the position of the user is used as a reference is maintained.

8. A recording medium on which the audio signal output adjusting process program according to claim 7 is computer-readably recorded.
